(19) United States
(12) Patent Application Publication
(10) Pub. No.: US 2025/0255321 A1
(43) Pub. Date: Aug. 14, 2025

(54) VEGETABLE SPREAD WITH COCOA BUTTER

(71) Applicant: CARGILL, INCORPORATED, Wayzata, MN (US)

(72) Inventors: Rob DEKKER, Delfgauw (NL); Dimitrios LYKOMITROS, Wormer (NL); Anne MERTENS-HOYNG, Badhoevedorp (NL)

(73) Assignee: CARGILL, INCORPORATED, Wayzata, MN (US)

(21) Appl. No.: 19/116,409

(22) PCT Filed: Oct. 9, 2023
(86) PCT No.: PCT/US2023/076337

§ 371 Date: Mar. 28, 2025

(30) Foreign Application Priority Data
Oct. 11, 2022 (EP) 22200932.6

(51) Int. Cl. A23D 7/00

(52) U.S. Cl. CPC A23D 7/001

(57) ABSTRACT

The present disclosure relates to a fat composition having a triglyceride composition comprising, expressed on the total weight of the triglycerides, a combined content of SU2 and U3 in range of from 12 to 72 wt. % and a content of SUS in a range of 20 to 50 wt. %, and a fatty acid profile comprising, expressed on the total weight of the fatty acids, a content of lauric acid (C12) in a range from 2 to 20 wt. %. The present disclosure also relates to a fat continuous emulsion comprising the fat composition according to the invention and an aqueous solution. The present disclosure further relates to the use of the fat continuous emulsion as an edible butter replacer.

### CROSS-REFERENCE TO RELATED APPLICATIONS

This application claims the benefit of European Application No. 22200932.6 filed Oct. 11, 2022, which is incorporated by reference herein in its entirety.

### FIELD OF THE INVENTION

The present invention relates to a fat composition and a fat continuous emulsion comprising the fat composition and an aqueous solution. The invention further relates to a use of the fat continuous emulsion as an edible butter replacer.

### BACKGROUND

There is a growing interest to look for plant based and vegan food options for both environmental and animal friendly reasons. Vegetable based margarines and vegetable spreads have already existed for a long time on the market as a plant-based alternative for dairy based butters, but the taste and eating experience are not at par with dairy based butters.

WO 2015/110390 describes fat blends and uses thereof in margarins and spreads.

There is still a need in the industry for plant-based margarines or vegetable spreads having improved textural properties and/or melting behavior.

### SUMMARY

The present disclosure provides a fat composition having a triglyceride composition comprising, expressed on the total weight of the triglycerides, a combined content of SU2 and U3 in range of from 12 to 72 wt. % and a content of SUS in a range of 20 to 50 wt. %, and a fatty acid profile comprising, expressed on the total weight of the fatty acids, a content of lauric acid (C12) in a range from 2 to 20 wt. %.

The present disclosure also provides a fat continuous emulsion comprising, expressed on the total weight of the emulsion, the fat composition according to the invention in a range of from 35 to 85 wt. % and an aqueous solution in a range of from 15 to 65 wt. %.

The present disclosure further provides a use of the fat continuous emulsion according to the invention as an edible butter replacer.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless otherwise indicated, the phrase “suitable for human consumption” means that the composition is generally recognized as safe for eating and drinking and as not being toxic, poisonous, or otherwise harmful to humans when used in functionally useful amounts in solid and liquid food products.

Unless expressly stated, ppm (parts per million), percentage, and ratios are on a by weight basis. Percentage on a by weight basis is also referred to as wt. % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, “room temperature” or “RT” refers to a temperature between 20° C. to 25° C.

### Fat Composition

The present disclosure provides a fat composition having a triglyceride composition comprising, expressed on the total weight of the triglycerides, a combined content of SU2 and U3 in range of from 12 to 72 wt. % and a content of SUS in a range of 20 to 50 wt. %, and a fatty acid profile comprising, expressed on the total weight of the fatty acids, a content of lauric acid (C12) in a range from 2 to 20 wt. %.

Triglyceride may be characterized by the position of the saturated(S) and/or unsaturated (U) fatty acids bound onto the glycerol backbone of the triglycerides. Typically, the abbreviation S is used to denote a saturated fatty acid residue having 8 to 24 carbon atoms. The abbreviation U denotes an unsaturated fatty acid residue having 8 to 24 carbon atoms. A triglyceride having one saturated fatty acid and two unsaturated fatty acids, independent of their relative position onto the glycerol backbone, is denoted SU2. A triglyceride having three unsaturated fatty acids is denoted U3. A triglyceride having two saturated fatty acids and one unsaturated fatty acid, independent of their relative position onto the glycerol backbone, is denoted S2U. More specifically, an S2U triglyceride having two saturated fatty acids at the 1-and 3-positions of the glycerol backbone and an unsaturated fatty acid at the 2-position is denoted SUS. An S2U triglyceride having two saturated fatty acids at the 1-or 3-position and at the 2-position of the glycerol backbone and an unsaturated fatty acid at the remaining 1-or 3-position is denoted SSU.

The triglyceride composition according to the present invention is comprising, expressed on the total weight of the triglycerides, a combined content of SU2 and U3 in a range of from 12 to 72 wt. %, preferably from 18 to 65 wt. %, or more preferably from 25 to 55 wt. %.

The SU2 and U3 fatty acids may be sourced from liquid oils. The term “liquid oil” is defined as triglycerides with a melting point of less than 20° C. The liquid oil can be one liquid oil or a blend of more than one liquid oils. In case of a blend of liquid oils, it is understood that the blend of the more than one liquid oil has a melting point of less than 20° C.

In one aspect, the “liquid oil” is a vegetable oil. Examples of vegetable liquid oils are amongst others double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of mono-unsaturated fatty acids compared to the original seed variety, such as mid or high oleic sunflower oil. These varieties with increased levels of mono-unsaturated fatty acids can be obtained by natural selection or by genetic modification (GMO). Preferably, the vegetable oil is selected from the group consisting of cottonseed oil, com oil, groundnut oil, linseed oil, olive oil, rapeseed oil, rice bran oil, sesame oil, safflower oil, soy bean oil, sunflower oil, their corresponding high oleic varieties, and mixtures of two or more thereof. More preferably, the vegetable oil is selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the triglyceride composition.

The triglyceride composition according to the present invention is comprising, expressed on the total weight of the triglycerides, a content of SUS in a range of from 20 to 50 wt. %, preferably from 22 to 42 wt. %, or more preferably from 25 to 37 wt. %.

The SUS triglyceride may be sourced from fats rich in symmetrical triglycerides such as cocoa butter, shea butter, sal, mango kernel, illipe butter, or their stearin or olein fractions, and palm mid fractions. Preferably, the symmetrical fat is cocoa butter, shea stearin, or shea butter.

Preferably, the triglyceride composition is comprising SUS and SSU such that the ratio of SUS over SSU (SUS/SSU) is in a range of more than 10, more than 20, or more than 30. Preferably, the fat composition according to the present invention is not an interesterified fat composition.

The fatty acid profile of the fat composition according to the invention is comprising, expressed on the total weight of the fatty acids, a content of C12 fatty acids in a range of from 2 to 20 wt. %, preferably from 5 to 17 wt. %, or more preferably from 8 to 15 wt. %, most preferably from 10 to 12 wt. %.

The term “fatty acid profile” of an oily substance, such as an oil or a fat, as used in the present disclosure, means the total of fatty acids that is present in the oily substance in the form of free fatty acids and in the form of the fatty acid moiety of a lipid (monoglyceride, diglyceride or triglyceride). For example, if an oil is comprising an amount of lauric acid expressed on total weight of the fatty acid profile, this amount is the total of lauric acid present in the oil as a free fatty acid and as lauric acid bound as the fatty acid moiety in the triglycerides, diglycerides and monoglycerides that are present in the oil.

The C12 fatty acids of the fatty acid profile may be sourced from lauric fats. Examples of lauric fats include, but are not limited to, coconut oil, hydrogenated coconut oil, palm kernel oil, fully or partially hydrogenated palm kernel oil, palm kernel stearin, hydrogenated palm kernel stearin, palm kernel olein, fully or partially hydrogenated palm kernel olein, or a mixture of two or more thereof. Preferably, lauric fats include, but are not limited to, coconut oil, palm kernel oil, palm kernel stearin, palm kernel olein. More preferably, lauric fats are coconut oil or palm kernel oil, Most preferably, the C12 fatty acids of the fatty acid profile may be sourced from coconut oil.

In one aspect, the fatty acid profile of the fat composition according to the invention can also comprise, expressed on the total weight of the fatty acids, a combined content of palmitic acid (C16) and stearic acid (C18) in a range of from 15 to 40 wt. %, from 18 to 35 wt. %, or from 20 to 30 wt. %.

The C16 and/or C18 fatty acids of the fatty acid profile may be sourced from non-lauric fats include, but are not limited to, palm-based oil, cocoa butter, shea butter, shea stearin, shea olein. liquid oils such as sunflower oil, rapeseed oil, cottonseed oil or soybean oil, or any combination of two or more thereof. The triglycerides may be hydrogenated and/or fractionated. The term “palm-based oil” is an oil selected from the group consisting of a palm oil, palm oil stearin, palm oil super stearin, palm oil olein, palm oil super olein, palm oil mid-fraction and blends of one or more thereof. Preferably, the C16 and/or C18 fatty acids of the fatty acid profile may be sourced from the group of fats consisting of cocoa butter, shea butter, shea stearin, sal, mango kernel, illipe butter, fully hydrogenated sunflower oil, fully hydrogenated rapeseed oil, fully hydrogenated cottonseed oil, fully hydrogenated soy bean oil, palm oil mid-fractions having an iodine value in a range of from 30 to 48, and any combination of two or more thereof. More preferably, the C16 and/or C18 fatty acids of the fatty acid profile may be sourced from the group of fats consisting of cocoa butter, shea butter, shea stearin, sal, mango kernel, illipe butter, and any combination of two or more thereof.

Preferably, the fatty acid profile of the fat composition according to the invention is comprising C16 and C18 such that the ratio of C18 over C16 is in a range of from 0.6 to 1.8. from 0.8 to 1.6, or from 1.0 to 1.5. Preferably, the C16 and C18 fatty acids of the fatty acid profile having a C18 over C16 ratio in a range of from 0.6 to 1.8 may be sourced from cocoa butter.

In one aspect of the invention, the fat composition is having a solid fat content at 10° C. (N10 value) in a range of from 25.0 to 35.0 and at 20° C. (N20 value) in a range of from 0.0 to 20.0, from 0.1 to 15.0. or from 0.2 to 10.0. The fat composition may have a solid fat content at 35° C. (N35 value) at a maximum of 5.0, at a maximum of 4.0, or at a maximum of 3.0. Solid fat content is measured according to standard methods AOCS Cd 16b-39 or IUPAC 2.150a. Preferably the fat composition is having a solid fat content at 10° C. (N10 value) in a range of from 25.0 to 35.0 and at 20° C. (N20 value) in a range of from 1.0 to 7.0, and at 30° C. (N30 value) a maximum of 3.0. Surprisingly, the texture of the invention is very hard at low temperature, but melts very quickly on eating, giving it a very pleasant eating experience. Without being bound by any specific theoretical explanation or interpretation, this interesting melting profile, such as soft and fast melting is obtained amongst others by the fatty acid profile of the fat composition wherein expressed on the total weight of the fatty acids, the content of C12 fatty acids in a range of from 2 to 20 wt. %, preferably from 5 to 17 wt. %, or more preferably from 8 to 15 wt. %, most preferably from 10 to 12 wt. %.

Preferably, the fat composition according to the invention comprises substantially no fats sourced from palm. Examples of sources of fats from palm are palm oil, palm oil fractions, palm kernel oil, palm kernel oil fractions or any combination of two or more thereof.

Preferably, the fat composition according to the invention comprises substantially no fats sourced from animals.

Preferably, the fat composition according to the invention comprises substantially no hydrogenated fats.

In a preferred aspect of the present disclosure, the fat composition has a triglyceride composition and a fatty acid profile, wherein the fatty acids of the fat composition are not sourced from palm and/or hydrogenated fats, and are not interesterified. The triglyceride composition of the fat composition has: a combined content of SU2 and U3 in a range of from 12 to 72 wt. %, from 18 to 65 wt. %, or from 25 to 55 wt. %, or from 43 to 53 wt. % based on the total weight of the triglycerides; a content of SUS in a range of from 20 to 50 wt. %, from 22 to 42 wt. %, or from 25 to 37 wt. % based on the total weight of the triglycerides; and a SUS/SSU ratio in a range of more than 10, more than 20, or more than 30. The fat acid profile of the fat composition has: a content of C12 in a range of from 2 to 20 wt. %, from 5 to 20 wt. %, or from 8 to 20 wt. %; a combined content of C16 and C18 in a range of from 15 to 40 wt. %, from 18 to 35 wt. %, or from 20 to 30 wt. %; and a ratio of C18 over C16 in a range of from 0.1 to 1.5, from 0.3 to 1.4, or from 0.5 to 1.2.

In another preferred aspect of the present disclosure, the fat composition is comprising, expressed on total weight of the fat composition:
Liquid oil in a range of from 10 to 75 wt. %, from 20 to 66 wt. %, or from 26 to 57 wt. %;
Coconut oil in a range of from 5 to 40 wt. %, from 12 to 40 wt. %, or from 18 to 40 wt. %; and
Cocoa butter in a range of from 20 to 50 wt. %, from 22 to 40 wt. %, or from 25 to 34 wt. %.

### Fat Continuous Emulsion

Fat composition of the present disclosure is suitable for use in a fat continuous emulsion. The emulsion is a water-in-oil emulsion and comprises an aqueous solution. Examples of fat continuous emulsion are, but are not limited to, margarines or spreads. A typical way to overcome grain formation and/or unpleasant sandy mouthfeel, is by using in the margarines or spreads interesterified fats, wherein the content of SUS is reduced and the content of SSU is increased. The current invention has demonstrated surprisingly that a fat composition that is not containing interesterified fats is providing the appropriate texture to the margarines or spreads without grain formation and/or unpleasant sandy mouthfeel.

The fat continuous emulsion comprises, expressed on the total weight of the emulsion, the fat composition according to the invention in an amount of from 35 to 85 wt. %. 45 to 82 wt. %, or from 55 to 80 wt. %.

The fat continuous emulsion comprises, expressed on the total weight of the emulsion, the aqueous solution in an amount of from 10 to 65 wt. %, from 15 to 55 wt. %, or from 18 to 45 wt. %.

The aqueous solution may include, but not limited to, water, cow's milk, sheep's milk, goat's milk, juices from plants or fruits, or combinations of two or more thereof. Examples of juices of plants or fruits may include, but not limited to, juice of beetroot, cauliflower, celery, apple, almonds, soy beans (also called soy “milk”), hazelnut, coconut (also called coconut “milk”), carrot, cucumber, and the like. Preferably, the aqueous solution is water, an aqueous solution from a vegetable origin, or any combinations thereof.

The fat continuous emulsion of the present disclosure may further comprise other ingredients including, but not limited to, emulsifiers, flavoring agents, coloring agents, preservatives or combinations of two or more thereof.

Emulsifiers may include, but not limited to, lecithin, mono-and/or di-glycerides, polyglycerolesters of fatty acids, citric acid esters of monoglycerides, or combinations of two or more thereof. The emulsifiers may be present in the fat continuous emulsion in an amount of 0.5 to 2 wt. % expressed on the total weight of the emulsion.

Flavoring agents may include, but not limited to, butter-flavoring ingredients, cheese-flavoring ingredients, garlic-flavoring ingredients, truffle-flavor ingredients, tomato-flavor ingredients, fresh or dried herbs, salt, spices, powders (e.g., milk powder, cheese powder, powder sugar, cocoa powder), sundried tomatoes, bell peppers, or combinations of two or more thereof. The flavoring agents may be artificial or natural flavoring agents. Preferably, the flavoring agent is a natural flavoring agent.

Coloring agents may include, but not limited to, carotene juice, carrot juice, beetroot, chlorophyl, lycopene, or combinations of two or more thereof. The coloring agents may be artificial or natural coloring agents. Preferably, the coloring agent is a natural coloring agent.

Preservatives may include, but not limited to, potassium, sodium or calcium salts of sorbic acid, benzoic acid, or a combination of two or more thereof. Often preservatives may be combined with citric acid to lower pH below 4. The preservatives may be artificial or natural preservatives. Preferably, the preservative is a natural preservative.

Preferably, the fat continuous emulsion comprises substantially no ingredients derived from palm oil.

Preferably, the fat continuous emulsion is plant-based and comprises substantially no ingredients derived from animals.

Preferably, the fat continuous emulsion of the present disclosure is edible. The emulsion can be used as a spread or a margarine which can be directly consumed without a need of any further process of food preparation (e.g., baking) prior to consumption.

It has been found that the fat composition or the fat continuous emulsion of the present disclosure has a pleasant melting behavior that is closely resembling butter. It is fast melting in the mouth and does not leave a fatty or waxy sensation in the mouth after melting.

In order to come to this pleasant melting behavior, the fat composition or the fat continuous emulsion needs to contain a significant amount of symmetrical triglycerides, as well as a specific content of the C12 fatty acids moiety. Preferably, the symmetrical fat is cocoa butter, shea stearin, or shea butter. More preferably, the symmetrical fat is cocoa butter. Preferably the symmetrical fat is combined with a lauric fat. More preferably cocoa butter is combined with coconut oil, while SU2 and U3 fatty acids may be sourced from liquid oils. Surprisingly, the fat continuous emulsion has a smooth texture and does not show any grainy texture due to re-crystallization of the fats.

### Use of Fat Continuous Emulsion

The present disclosure also relates to a use of the fat continuous emulsion according to the invention as an edible butter replacer. The edible butter replacer can be applied as a spread or a margarine and be directly consumed. The edible butter replacer can be used as is. It does not have to be further processed (e.g., baked, cooked) before it is suitable for consumption.

### Process of Preparation of Fat Continuous Emulsion

The fat continuous emulsion of the present disclosure can be prepared as follows. Oil phase of the emulsion is prepared by providing the fat composition of the present disclosure in a melted form (+/−60° C.) and keeping it at a temperature of more than 40° C. The actual temperature depends on, for example, the composition of the emulsion and the emulsifiers used. Emulsifiers and additional fat-soluble ingredients, such as fat-soluble flavors, are added to the oil phase.

Water phase of the emulsion is prepared and kept at 45° C.

The oil phase and the water phase are then mixed and homogenized to obtain the emulsion. The emulsion is subsequently cooled down by, for example, a scraped surface heat exchanger. After cooling, the emulsion is in a paste form and stored cool between 4 and 7° C.

The emulsion is then be used to prepare a spread by any conventional method for making margarines or other water-in-oil spreads known to a person skilled in the art.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Fat Composition

A preferred composition of the fat blends, the triglyceride composition of the fat composition, the fatty acid profile of the fat composition, and the melting profile of the fat composition are shown in Table 1.

Table 1 also shows the composition, the fatty acid profile and the melting profile of a comparative example wherein the fat blend is consisting of rapeseed oil and shea butter stearin (according to example 1-1 in WO 2015/110390)

TABLE 1

| | | Comparative example |
|---|---|---|
| | | (expressed on total weight |
| | | of the fat composition) |
| Composition of the fat blend (expressed | | |
| on total weight of the fat composition) | | |
| Rapeseed oil | 47.5 wt. % | 50.0 wt. % |
| Coconut oil | 21.0 wt. % | — |
| Cocoa butter | 31.5 wt. % | — |
| Shea butter stearin | — | 50.0 wt. % |
| Triglyceride composition of the | | |
| fat composition (expressed on | | |
| total weight of the triglycerides) | | |
| SU2 + U3 | 49.0 wt. % | 40.8 wt. % |
| SUS | 31.8 wt. % | 43.3 wt. % |
| SSU | 0.6 wt. % | 0.2 wt. % |
| SUS/SSU | 53.0 | |
| Fatty acid profile of the fat composition | | |
| (expressed on total weight of the fatty acids) | | |
| C12:0 | 10.1 wt. % | 0.0 wt. % |
| C16:0 | 12.0 wt. % | 3.8 wt. % |
| C18:0 | 13.6 wt. % | 31.4 wt. % |
| C16:0 + C18:0 | 25.7 wt. % | 35.2 wt. % |
| C18/C16 | 1.1 | 8.2 |
| Melting profiles - Solid Fat Content | | |
| (SFC) according to IUPAC 2.150a | | |
| at 10° C. | 30.0 wt. % | 41.6 wt. % |
| at 20° C. | 13.0 wt. % | 38.6 wt. % |
| at 30° C. | 0.0 wt. % | 13.0 wt. % |
| at 35° C. | 0.0 wt. % | 1.7 wt. % |

The fat blends of the present invention show improved textural properties and/or melting behavior. The fat blends of the present invention melt much faster in the mouth, because of the heat from the mouth. This gives the pleasant melting sensation in the mouth.

### Example 2—Recipe of Fat Continuous Emulsion

The recipe of the fat continuous emulsion is shown in Table 2, in which concentrations of the ingredients are measured in wt. % based on the total weight of the emulsion.

TABLE 2

| Ingredient | Concentration | |
|---|---|---|
| Fat composition according to Example 1 | 76 | wt. % |
| Sunflower lecithin | 0.3 | wt. % |
| Water | 19.44 | wt. % |
| Salt | 0.2 | wt. % |
| Butter flavor | 0.06 | wt. % |
| Carrot juice | 4 | wt. % |

### Example 3—Preparation of the Fat Continuous Emulsion

The following steps were taken to prepare the fat continuous emulsion with recipe as shown in Table 2:
(1). Cocoa butter, coconut oil, liquid oil, and sunflower lecithin were mixed and heated between 60 to 70° C. to obtain an oil phase.
(2). Water and salt were mixed and heated to 45° C. to obtain a water phase.
(3). The oil phase was poured into a bowl and the bowl was put in a bath of ice water. The oil phase was continuously beaten with a mixer. The water phase was slowly added to the oil phase and the emulsion was obtained.
(4). The emulsion was cooled down to 10° C.

1. A fat composition having:
a. a triglyceride composition that comprises, expressed on the total weight of the triglycerides:
i. a combined content of SU2 and U3 in a range of from 12 to 72 wt. %; and
ii. a content of SUS in a range of from 20 to 50 wt. %; and
b. a fatty acid profile that comprises, expressed on the total weight of the fatty acids:
i. a content of lauric acid (C12) in a range of from 2 to 20 wt. %.

2. The fat composition according to claim 1, wherein the triglyceride composition has a ratio of SUS over SSU in a range of more than 10.

3. The fat composition according to claim 1, wherein the fatty acid profile further comprises, expressed on the total weight of the fatty acids, a combined content of palmitic acid (C16) and stearic acid (C18) in a range of from 15 to 40 wt. %.

4. The fat composition according to claim 1, wherein the fatty acid profile has a ratio of C18 over C16 in a range of from 0.6 to 1.8.

5. The fat composition according to claim 1, wherein the fat composition is not interesterified.

6. The fat composition according to claim 1, wherein the fat composition comprises substantially no fats derived from palm.

7. The fat composition according to claim 1, wherein the fat composition comprises substantially no fats derived from animals.

8. The fat composition according to claim 1, wherein the fat composition comprises substantially no hydrogenated fats.

9. The fat composition according to claim 1, wherein the fat composition comprises, expressed on total weight of the fat composition:
Liquid oil in a range of from 10 to 75 wt. %;
Coconut oil in a range of from 5 to 40 wt. %; and
Cocoa butter in a range of from 20 to 50 wt. %.

10. A fat continuous emulsion comprising, expressed on the total weight of the emulsion:
a. the fat composition according to any one of claims 1 to 9 in a range of from 35 to 85 wt. %; and
b. an aqueous solution in a range of from 15 to 65 wt. %.

11. The fat continuous emulsion according to claim 10, further comprising one or more of the following:
a. one or more emulsifier(s);
b. one or more flavoring agent(s); and
c. one or more coloring agent(s).

12. Use of the fat continuous emulsion according to claim 10 as an edible butter replacer.

13. Use of the fat continuous emulsion according to claim 11 as an edible butter replacer.
